(19) United States
(12) Patent Application Publication
(10) Pub. No.: US 2006/0157508 A1
(43) Pub. Date: Jul. 20, 2006

(54) Device for storing and dispensing fluid substances

(76) Inventors: Matthias Suchan, Hachenburg (DE); Alexander Bublewitz, Herborn (DE)

Correspondence Address: WILLIAM COLLARD;COLLARD & ROE, P.C., 1077 NORTHERN BOULEVARD, ROSLYN, NY, 11576, US

(21) Appl. No.: 11/103,691

(22) Filed: Apr. 12, 2005

(30) Foreign Application Priority Data
Jan. 20, 2005 (DE) 10 2005 002 850.0

(51) Int. Cl. B67B 5/00; B67D 5/32; B67D 5/33; B67D 5/378

(52) U.S. Cl. 222/153.01

(57) ABSTRACT

A device for storing and dispensing fluid substances has at least one container having at least two cartridges for accommodating fluid substances. The container is provided with at least two outlet nozzles on its face, to which a dispensing element can be releasably locked by way of at least one spring segment. Particularly simple operation of the device and a secure hold of the dispensing element can be achieved in that a locking element is associated with the at least one spring segment. The locking element is movable relative to the at least one spring segment and can be moved from a first, open position in which the at least one spring segment is released, into a second, locking position in which the spring segment is brought into engagement with the dispensing element to lock it.

### CROSS REFERENCE TO RELATED APPLICATIONS

Applicants claim priority under 35 U.S.C. §119 of German Application No. 10 2005 002 850.0 filed Jan. 20, 2005.

### BACKGROUND OF THE INVENTION

1. Field of the Invention

The present invention relates to a device for storing and dispensing fluid substances. The device has at least one container for accommodating fluid substances, provided with at least one outlet nozzle on its face, a dispensing element, and at least one spring segment that is connected to pivot with the container and/or at least one outlet nozzle, for releasable locking of the dispensing element on the outlet nozzle(s) of the container.

2. The Prior Art

Dual cartridges or dual syringes, for example, formed from two cylinders, in which the fluid substances are stored separate from one another, are known for storing and dispensing fluid substances from which multi-component materials for dental purposes can be mixed, for example. Before use, these substances are dispensed from the device by means of a dispensing element, and mixed with one another, causing the substances to react with one another and cure. In many cases, an amount of the fluid substances that is sufficient for several applications is stored in the dual cartridges or dual syringes. The dispensing elements, which can be a static or dynamic mixer, for example, are therefore mainly disposable articles that must be attached to the container for use and afterwards must be releasable from it, to dispose of them.

DE 102 58 953 A1 describes a dispensing device for fluid substances in which two elastically deformable spring arms are provided on the outlet nozzle of the container or on the mixer itself. The arms form a releasable catch closure for connecting the mixer with the container. To connect the mixer with the container, the mixer must consequently be set onto the container, whereby the spring arms engage behind a flange-shaped region on the mixer or the container, respectively, snapping in place. To release the mixer, the spring arms of the known device are spread apart, so that these release the flange-shaped region on the mixer or the container, respectively.

Removing the mixer, in particular, has proven to be difficult, since for this purpose, the container has to be held firmly, the spring arms have to be spread apart and, at the same time, the mixer has to be pulled off. Consequently, one-hand operation is not possible with this known dispensing device. In addition, there is the risk that when the fluid substances are dispensed from the container, the spring arms will pivot apart from one another unintentionally, and release the mixer. As a result, the mixer can come loose from the container, due to the high dispensing pressure of the fluid substances.

A dispensing arrangement is also known from EP 1 440 737 A1, in which a mixer can be attached, by means of a coupling ring having a thread, to a corresponding thread of a dispensing device or a cartridge. In this way, while a secure hold of the mixer on the container is achieved, attaching the mixer is time-consuming. Furthermore, if the coupling ring is not completely screwed onto the container, there is the risk that the mixer will come loose from the container to such an extent that the fluid substances can exit and react with one another.

### SUMMARY OF THE INVENTION

It is an object of the present invention to further develop a device of the type stated initially, so that, in contrast with the known arrangements, a dispensing element can be simply and securely attached to a container and be releasable from it again.

This object is accomplished, according to one aspect of the invention, by assigning a locking element to the at least one spring segment. The locking element is movable relative to the at least one spring segment and can be moved from a first, open position in which the at least one spring segment is released, into a second, locking position in which the spring segment is brought into engagement with the dispensing element, to lock it.

In the open position, a dispensing element can be set onto the container or taken off it, without the spring segments having to come into contact with the dispensing element. This arrangement allows particularly convenient one-hand operation, because the dispensing element merely has to be set onto the container or pulled off from it. When the locking element has been brought from its open position into the locking position, the at least one spring segment is brought into contact with the dispensing element. The contact is such that the at least one spring segment locks the dispensing element and reliably prevents the dispensing element from falling-off unintentionally.

If a single-component system is supposed to be stored and/or dispensed using the device according to the invention, the container can be formed by only one cartridge or the like. However, impression masses for the dental sector are frequently mixed as two-component or multi-component systems. Here it is preferred if the container is a dual cartridge or a dual syringe formed by two cylinders that are connected with one another, for example, on which two outlet nozzles are provided. However, the shape of the container is not restricted to two cylinders that are oriented parallel to one another and connected with one another laterally. Instead, the cartridges or the like can also be disposed coaxially inside one another, for example, whereby a smaller cartridge is accommodated in a larger cartridge. Furthermore, the containers can also have an oval or rectangular cross-section, for example. The term “cylinder” is therefore used merely as an example in the following, for a possible shape of the containers.

In this connection, the dispensing element can be a static or particularly a dynamic mixer that has two inlet nozzles that are complementary to the outlet nozzles of the container, at least in certain regions, and a flange-shaped edge on the side of the inlet nozzles, with which the at least one spring segment can be brought into engagement for locking it.

Two spring segments, in particular, may be mounted on the outlet nozzles, so that each spring segment can be reversibly pivoted from a first, open position which releases the dispensing element, into a second, locking position, which locks the dispensing element onto the outlet nozzle. With this arrangement, repeated removal and reliable placement of dispensing elements on the container is possible. In this connection, it has proven to be advantageous if each spring segment has a projection that surrounds the flange-shaped edge in the locking position. The flange-shaped edge can also delimit the displacement path of the locking element, according to an aspect of the invention.

According to a preferred embodiment, each spring segment projects away from the container, in its non-stressed position, which corresponds to the open position. In this way, the dispensing element can be set onto the container without entering into contact with the spring segments. In this connection, the spring segments can extend at an angle of about 450 relative to the axes of the outlet nozzles, for example. In this way, setting the dispensing element on or removing it is made possible in particularly simple manner and, in particular, with one hand.

As an alternative to this arrangement, the device may be designed so that each spring segment projects away from the container, in its non-stressed position, so that the spring segments form a catch closure for the dispensing element. The dispensing element is then already fixed in place on the container after it has been set on, without any activation of the locking element. In this embodiment, to remove the dispensing element, either the spring segments have to be spread apart, or they release the dispensing element when pulled off with sufficient force.

The locking element can have a ring surrounding at least two spring segments, which ring is displaceable essentially parallel to the axes of the outlet nozzles. In this way, the ring can make the spring segments rest against the dispensing element in its locking position, and thereby fix the dispensing element in place. For simpler handling of the locking element, one or more handle-shaped projections can be provided on the ring.

Furthermore, according to a further aspect, the ring is held on the spring segments and/or the container so as not to come off. This arrangement further improves the handling of the device according to the invention. This arrangement prevents the ring from falling off unintentionally, which would impair the function of the device.

According to a preferred embodiment of the invention, the spring segments can be hinged onto at least one ridge or the like, by way of a weakened articulation region. In this connection, the ridge, a plate, or a similar component, can be rigidly connected with the outlet nozzle and/or the container. If the dispensing element is a dynamic mixer, a passage opening is preferably provided in the ridge or the like. The mixer shaft can be passed through the passage opening. Such a passage opening or open area between the outlet nozzles also has the effect that mixing of the substances stored in the device, on a ridge or the like, is prevented to a great extent. This undesirable mixing could result in curing of the substances in the region of the outlet nozzles, causing these to become clogged.

Unintentional mixing of the substances accommodated in the device, in the region of the outlet nozzles, can also be prevented in that the ridge or the like, on which the at least one spring segment is hinged, is set back relative to the ends of the outlet nozzles, in the direction towards the container.

According to one embodiment of the invention, each spring segment has at least one first arm provided with the projection for locking the dispensing element. Each spring segment may additionally have a second arm that extends at an obtuse angle relative to the first arm, in the direction towards the container. With this arrangement, the spring segments can be moved into the position that releases the dispensing element, by means of the second arms.

In a further embodiment, the locking element can be pushed on, over the second arms of the spring segments, so that they release an opening through which the dispensing element can be set onto the container, without coming into contact with the first arms. In this embodiment, the spring segments can consequently be fixed in place not only in their position that locks the dispensing element, by means of the locking element, but also in their open position, in which the spring segments release the dispensing element.

Preferably, the container has at least one cartridge directly filled with the fluid substances. Alternatively, tubular bags or the like, in which the fluid substances are accommodated, can also be filled into the container. In this way, the cartridges can easily be used once or several times. The use of such tubular bags can also be advantageous if it is not possible to achieve sufficient storage stability when storing the fluid substances directly in the cartridges.

Preferably, the tubular bags are attached in the at least one cartridge, for example by means of gluing them in place. This glue connection can, at the same time, seal the tubular bags relative to the cartridges. The tubular bags in the cartridges can be opened by perforating them through the outlet nozzles, for example. In order to prevent exit of the substances during transport and storage, the outlet nozzles can be closed off with a plug or the like, so that a user merely has to remove the plugs before putting the device according to the invention into operation. At the same time, this embodiment permits one to eliminate the pistons that are usually used as closures with cartridges that are filled directly and that are provided at the back end of the cartridges. As an alternative to gluing a tubular bag in on the back wall of a cartridge, the bag can be glued onto a sealing ring, forming a seal. The ring may have a seal with a radial effect, for example, and may rest on the inside wall of the cartridge.

If two-component systems are stored and/or dispensed in the device according to the invention, the outlet nozzles are provided on faces that firmly close off one side, in each instance, of the cylinders of a dual cartridge that form the container. Alternatively, the outlet nozzles can also be provided on two caps that are rigidly connected with one another, which releasably close off a face of the cylinders of a dual cartridge forming the container, in each instance.

According to another embodiment of the invention, the cylinders are closed off by means of a separate cap having outlet nozzles, in each instance, into which a tubular bag can be glued. A connecting plate can then be set onto these caps and/or the cylinders, by way of a snap closure, for example. The spring segment as explained above, having the locking element, is disposed on the connecting plate to attach a mixer or the like.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In this connection, all the characteristics that are described and/or shown in the drawings represent embodiments of the invention, in themselves or in any desired combination, independent of their summarization in the claims or their antecedents.

In the drawings, wherein similar reference characters denote similar elements throughout the several views:

FIG. 1 is a side view of a first embodiment of the device according to the invention, in its open position;

FIG. 2 is a top view of the locking element shown in the embodiment of FIG. 1;

FIG. 3 is a side view of the locking element according to FIG. 2;

FIG. 4 is a side view of the device according to FIG. 1 in its locking position;

FIG. 5 is a side view of a second embodiment of the device according to the invention, in its open position;

FIG. 6 is a side view of the device according to FIG. 5 in its locking position;

FIG. 7 is a side view of a third embodiment of the device according to the invention; and

FIG. 8 is a side view of a fourth embodiment of the device according to the invention.

### DETAILED DESCRIPTION OF PREFERRED EMBODIMENTS

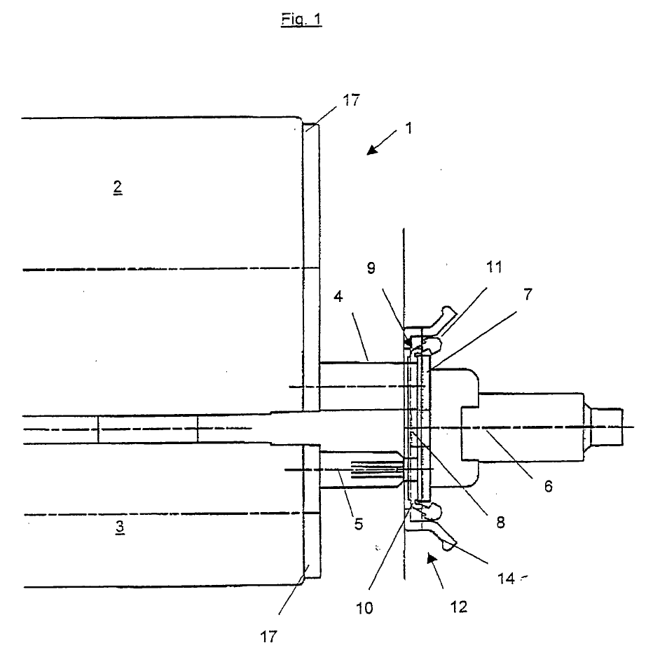

The device for storing and dispensing fluid substances, shown in FIGS. 1 and 4 to 6, has a container 1 having two cylinders or chambers 2, 3 forming a dual cartridge, for receiving various fluid substances. These substances can either be filled directly into cylinders 2, 3 or be accommodated in a tubular bag, not shown, which in turn is filled into the cylinders and connected with the inside cylinder wall, forming a seal.

Each of the two cylinders 2, 3 is provided with an outlet nozzle 4 and 5, respectively. Each outlet nozzle projects away from container 1 on the face. These outlet nozzles can be connected with a dispensing element 6, which is a dynamic mixer in the embodiments shown. For this purpose, dispensing element 6 has inlet nozzles whose size is dimensioned so that they can be inserted into outlet nozzles 4, 5 of container 1 or vice versa. Furthermore, dispensing element 6 is provided with a flange-shaped edge 7 on the end that faces container 1 in the figures, on which the inlet nozzles are also provided.

In the first embodiment shown in FIGS. 1 and 4, a ridge 8 or a plate is disposed between the two outlet nozzles 4 and 5. The ridge or plate is set back relative to the ends of the outlet nozzles, in the direction towards container 1. An opening or recess can be provided in ridge 8, through which a drive shaft, not shown, for mixer 6 can be passed. Two spring segments 10 are hinged onto ridge 8 so as to pivot, by way of an articulation region 9 weakened in the manner of a film articulation. Spring segments 10 are shown in their non-stressed open position in FIG. 1, in which they extend away from ridge 8 at an angle of approximately 45°.

In this open position, dispensing element 6 can pass through an opening circumscribed by spring segments 10, with its flange-shaped edge 7, in order to be set onto outlet nozzles 4, 5 or to be pulled off from them, respectively, without coming into contact with the spring segments 10.

Projections 11 are provided on the end of spring segments 10 that face away from container 1, which can engage behind flange-shaped edge 7 of dispensing element 6. Spring segments 10 have a locking position in which they extend approximately parallel to the axes of outlet nozzles 4, 5, for example, as shown in FIG. 4. When pivoted from their open position shown in FIG. 1 into their locking position, spring segments 10 with their projections 11 prevent dispensing element 6 from being pulled off from outlet nozzles 4, 5.

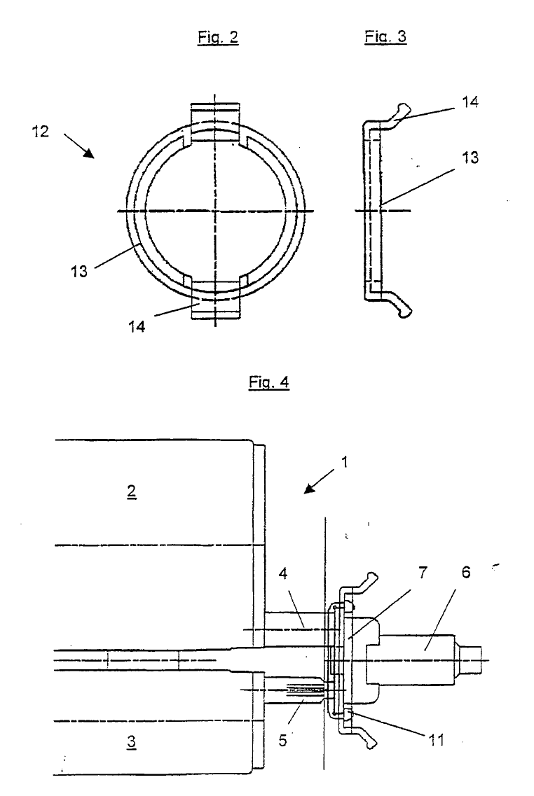

A locking element 12 shown in detail in FIGS. 2 and 3 is essentially formed by a ring 13 that is guided to be displaced on the outsides of spring segments 10, essentially in the direction of the axes of outlet nozzles 4, 5. In its open position, in which it is retracted in the direction towards container 1, ring 13 allows spring segments 10 to pivot outward into their non-stressed open position, as shown in FIG. 1.

On the other hand, when locking element 12 is displaced in the direction away from container 1, into its locking position, as shown in FIG. 4, ring 13 lays spring segments 10 against dispensing element 6, so that projections 11 engage behind flange-shaped edge 7. In the locking position according to FIG. 4, spring segments 10 can consequently not pivot outward, so that dispensing element 6 is held securely on container 1.

To remove dispensing element 6, locking element 12 merely has to be pushed back into its open position shown in FIG. 1, so that ring 13 allows spring segments 10 to spread open by themselves, and dispensing element 6 is released.

To make locking element 12 easier to handle, two handle-like projections 14 are provided on ring 13, with which ring 13 can be displaced. The configuration of projections 11 at the end of spring segments 10 prevents locking element 12 from being pushed beyond projections 11, away from container 1. In this way, locking element 12 is held on container 1 so that it cannot come off.

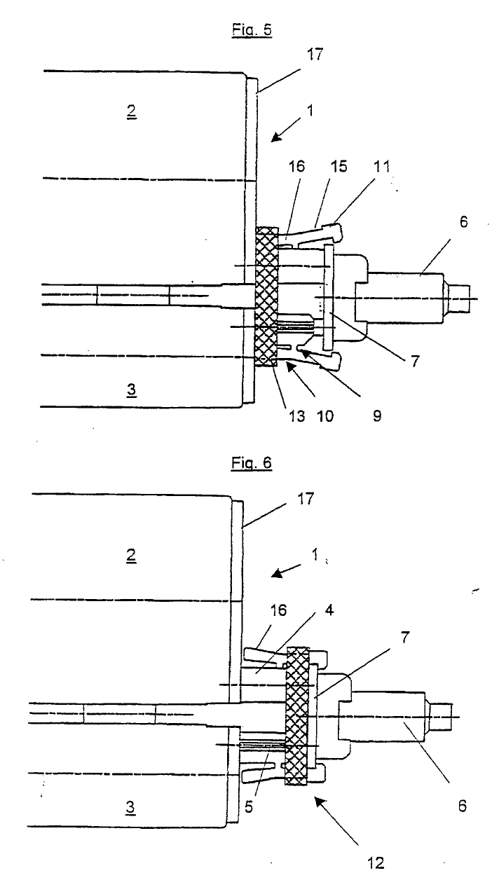

In the second embodiment of the invention shown in FIGS. 5 and 6, a spring segment 10 is hinged onto each outlet nozzle 4 and 5, respectively, so as to pivot, by way of a weakened articulation region 9. Spring segments 10 according to this second embodiment have a first arm 15 that extends away from articulated region 9, in the direction away from container 1. The previously described projections 11 are disposed at the end of first arms 15. In contrast to the first embodiment, a second arm 16 extends approximately in the opposite direction from first arms 15, from articulated region 9, towards container 1. As is evident from FIGS. 5 and 6, arms 15 and 16 run at an obtuse angle relative to one another.

In this embodiment, ring 13 of locking element 12 is also guided so that it can be displaced on spring segments 10. In the open position of locking element 12 shown in FIGS. 5, the element is retracted over articulated region 9, in the direction towards container 1. In this way, first arms 15 having projections 11 are spread apart, because ring 13 presses second arms 16 together. As a result, dispensing element 6 with its flange-shaped edge 7 can be set onto outlet nozzles 4, 5, or pulled off from them, without flange-shaped edge 7 coming into contact with projections 11.

To securely connect dispensing element 6 with container 1, locking element 12 is now, as shown in FIG. 6, pushed away from container 1 until ring 13 presses the first arms 15 together so that projections 11 of spring segments 10 securely engage around flange-shaped edge 7 of dispensing element 6.

Only locking element 12 needs to be displaced relative to container 1 in the embodiments shown, in order to secure dispensing element 6 on container 1 or to release it. As a result, particularly simple operation of the device according to the invention is possible even with only one hand.

Setting dispensing element 6 onto container 1 or removing it is easily possible in the open position shown in FIGS. 1 and 5, respectively, since projections 11 of spring segments 10 do not make contact with flange-shaped edge 7 of dispensing element 6. In contrast, displacement of locking element 12 into the locking position shown in FIGS. 4 and 6, respectively, can be used to effectively prevent unintentional release of dispensing element 6.

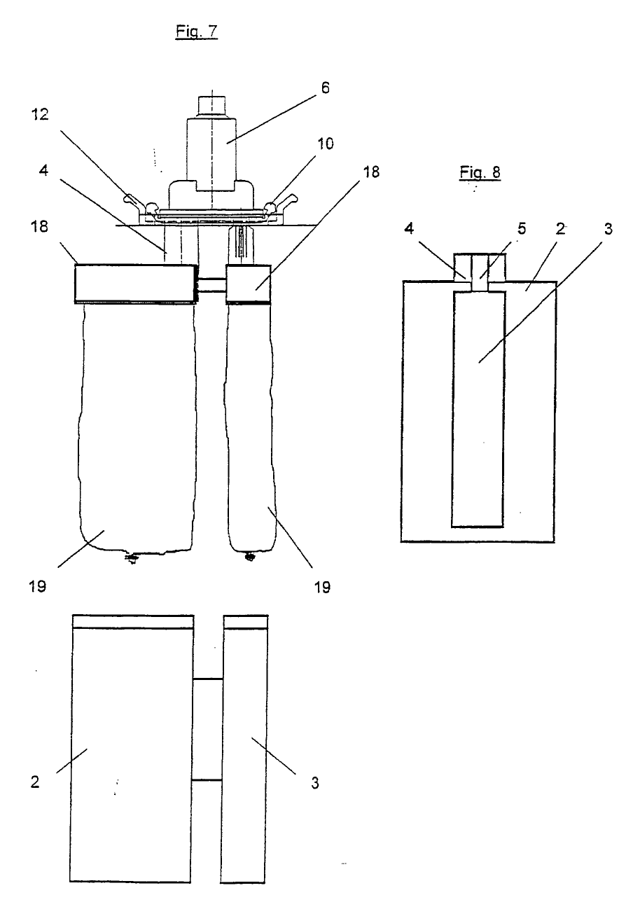

In FIGS. 1 and 4 to 6, cylinders 2, 3 are rigidly connected with one another to form a dual cartridge. In this connection, the cylinders are firmly closed off on the side facing dispensing element 6, by means of a face 17 that can be formed in one piece with the cylinders. As shown in FIG. 7, cylinders 2, 3 can also be closed off with releasable caps 18 that are connected with one another. In this connection, the two caps 18 do not have to be connected to form a single component, but rather can be connected with one another, for example, by means of a connecting plate that is not separately shown in the figures, which can be snapped onto caps 18 and/or cylinders 2, 3 once caps 18 have been placed on the cylinders. Spring segment 10 and locking element 12 are then disposed in the connecting plate. In the embodiment shown, caps 18 are glued together with tubular bags 19, forming a seal, so that tubular bags 19 which, like caps 18, are then disposable articles, can be introduced into cylinders 2, 3, which can be used multiple times.

As is evident from FIG. 8, cylinders 2, 3 do not have to be disposed parallel next to one another. Instead, the smaller cylinder 3 can also be accommodated in the larger cylinder 2, for example coaxially. In this connection, outlet nozzles 4, 5 of the two cylinders 2, 3 preferably exit coaxially from the face of the larger cylinder 2. In addition to the embodiments shown in FIGS. 1 to 8, the locking element according to the invention can be used not only for dual cartridges, but also for individual containers of single-component systems.

Although only a few embodiments of the present invention have been shown and described, it is to be understood that many changes and modifications may be made thereunto without departing from the spirit and scope of the invention as defined in the appended claims.

What is claimed is:

1. A device for storing and dispensing fluid substances comprising:
(a) at least one container for accommodating fluid substances, said at least one container having a face;
(b) at least one outlet nozzle provided on said face;
(c) a dispensing element;
(d) at least one spring segment pivotally connected with said at least one container or said at least one outlet nozzle for releasable locking of said dispensing element on said at least one outlet nozzle; and
(e) a locking element associated with said at least one spring segment, said locking element being movable relative to said at least one spring segment between a first, open position in which said at least one spring is released and a second, locking position in which said at least one spring segment is brought into engagement with said dispensing element to lock said dispensing element.

2. The device according to claim 1, wherein said at least one container comprises a dual cartridge having first and second chambers that are connected with one another, said at least one outlet nozzle comprising first and second outlet nozzles provided on said first and second chambers, respectively, and wherein said dispensing element comprises a mixer that has first and second inlet nozzles that are at least partially complementary to the first and second outlet nozzles and a flange-shaped edge on a side of the inlet nozzles, with which said at least one spring segment can be brought into engagement for locking said dispensing element.

3. The device according to claim 1, wherein said at least one spring segment comprises first and second spring segments mounted on the outlet nozzles so that each spring segment can be reversibly pivoted from the first, open position which releases the dispensing element, into the second, locking position, which locks the dispensing element onto the respective outlet nozzle.

4. The device according to claim 3, wherein each spring segment has a projection that engages around the flange-shaped edge in the locking position.

5. The device according to claim 3, wherein each spring segment projects away from said at least one container in a non-stressed position, so that said dispensing element can be set onto said at least one container without entering into contact with the spring segments.

6. The device according to claim 3, wherein each spring segment projects away from said at least one container in a non-stressed position, so that the spring segments form a catch closure for the dispensing element.

7. The device according to claim 2, wherein said at least one spring segment comprises at least two spring segments and said locking element has a ring surrounding said at least two spring segments, said ring being displaceable substantially parallel to axes of the outlet nozzles.

8. The device according to claim 7, wherein said ring has at least one handle-shaped projection.

9. The device according to claim 7, wherein said ring is held on the spring segments or said at least one container so as not to come off.

10. The device according to claim 3, wherein the spring segments are hinged onto at least one ridge by way of a weakened articulation area.

11. The device according to claim 10, wherein said at least one ridge comprises a perforated ridge.

12. The device according to claim 10, wherein said at least one ridge is set back at the outlet nozzles relative to ends of said outlet nozzles towards said at least one container.

13. The device according to claim 10, wherein each spring segment has at least one first arm provided with a projection for locking the dispensing element.

14. The device according to claim 13, wherein each spring segment has a second arm that extends towards said at least one container at an obtuse angle relative to the first arm.

15. The device according to claim 14, wherein said locking element can be pushed on, over the second arms so that the second arms release an opening through which said dispensing element can be set onto said at least one container without coming into contact with the first arms.

16. The device according to claim 1, wherein said at least one container has at least one chamber that is directly filled with the fluid substances.

17. The device according to claim 1, wherein said at least one container has at least one chamber filled with at least one tubular bag in which the fluid substances are accommodated.

18. The device according to claim 17, wherein said at least one tubular bag is secured in said at least one chamber to form a seal.

19. The device according to claim 18, wherein said at least one tubular bag is glued in place within said at least one chamber.

20. The device according to claim 2, wherein the outlet nozzles are provided on respective faces that firmly close off a side of the corresponding chamber of the dual cartridge.

21. The device according to claim 2, further comprising first and second caps, said first and second outlet nozzles being provided on said first and second caps, respectively, said caps being rigidly connected with one another, each cap releasably closing a face of the corresponding chamber of the dual cartridge.

22. The device according to claim 2, wherein the outlet nozzles are provided on two separate caps, said caps releasably closing off a respective face of the chamber of the dual cartridge, said device further comprising a connecting plate adapted to be set onto said caps or said chambers, said at least one spring segment and said locking element for attaching a mixer being disposed on said connecting plate.

23. The device according to claim 1, wherein said at least one container comprises first and second chambers, said first chamber being received within said second chamber, each chamber having an outlet nozzle, and both outlet nozzles being disposed on a face of the second chamber.
